(19) United States
(12) Patent Application Publication
(10) Pub. No.: US 2012/0206350 A1
(43) Pub. Date: Aug. 16, 2012

(54) Device Control of Display Content of a Display

(75) Inventors: Davy J. Figaro, Sebastopol, CA (US); Andrew T. Taylor, Santa Rosa, CA (US); George Hsu, Boca Raton, CA (US)

(73) Assignee: PNI SENSOR CORPORATION, Santa Rosa, CA (US)

(21) Appl. No.: 13/026,260

(22) Filed: Feb. 13, 2011

(51) Int. Cl. G06F 3/033; G09G 5/08

(52) U.S. Cl. 345/158; 345/157

(57) ABSTRACT

Methods, apparatuses and systems of providing control of display content on a display with a device are disclosed. One method includes establishing a fixed reference on the display. A user input is received indicating that the device is at a user selected position corresponding to the fixed reference and capturing a position of the device in order to establish a corresponding reference position. The display content on the display is determined based on measured displacement of the device relative to the established reference position.

### FIELD OF THE EMBODIMENTS

The described embodiments relate generally to a remote pointing device. More particularly, the described embodiments relate to a device that provides control of display content of a display.

### BACKGROUND

Computers and televisions are rapidly converging in the consumer home environment. This convergence is being driven by rapidly falling costs and increasing resolution of advanced display technologies, pervasive broadband internet access, and the quickly shifting paradigm of media content providers from that of limited broadcasted content, to the rich variety of individually selectable content that cable television and the “pay-for-play” internet-based services, such as iTunes®, with proven track records of phenomenal success. The traditional television is quickly evolving into the “entertainment computer” and is migrating towards the living room and other central gathering areas of the home. The modern television will not only be equipped for internet access, but also for cable, satellite, public spectrum HD broadcasts, on-demand movies and sports programming, and home media aggregation repositories, such as for video and photo storage and playback.

With the large asset investment of a large screen high-resolution display, it is clear that the content consumed will only continue to increase. This dramatic increase in content choice brings with it the need to find far more intuitive and efficient ways for the user to navigate to the programming or content of interest. User-friendly content navigation is key. The traditional button-based television remote control no longer suffices in navigating both the breadth and depth of this staggering volume of possible choices. Multi-level, icon-driven user command and navigation architectures hold the most immediate promise as a familiar and plausible way for a user to navigate such a large amount of content with some level of efficiency.

Operating Systems for televisions that use the traditional computer mouse and icon driven user interface facsimile have been created over the last several years. These new television operating systems provide the first step in solving the content navigation problem, but the traditional computer input devices of mouse, touchpad, or trackball as they are all meant to work on a fixed surface only a short distance from the screen, whereas a television remote control's paradigm is that of usage from medium to long distances from the screen in pointing and gesturing motions. In other words, these traditional computer input devices do not lend themselves to be used with familiarity or practicality as television remote control input devices, especially to manipulate icons as the means to content navigation. Gesture-based spatial point and select technology is needed, but the current state of the art, affordable technology combination of MEMS gyro and accelerometer only work in relative fashion with respect to three-dimensional motion. This does not allow “scrolling, a cursor across the screen” in a computer mouse equivalent drag, pick-up and drag again motion. Center reference is quickly lost and the user has no easy way of controlling the cursor on a television screen in a simple and intuitive manner.

It is desirable to have a method, system and apparatus for spatially absolute cursor control that has the characteristics of adjustable movement gain and scale that allows for user movement, screen size, and distance to screen adjustability.

### SUMMARY

One embodiment includes a method of providing control of display content on a display with a device. The method includes establishing a fixed reference on the display. A user input is received indicating that the device is at a user selected position corresponding to the fixed reference and capturing a position of the device in order to establish a corresponding reference position. The display content on the display is determined based on measured displacement of the device relative to the established reference position.

Another embodiment includes a device. The device includes means for receiving a user input indicating that the device is at a user selected position relative to an established fixed reference on a display. The device further includes means for receiving the user input and capturing a position of the device in order to establish a corresponding reference position. Display content on the display is determined based on measured displacement of the device relative to the established reference position.

Another embodiment includes a display system. The display system includes a display, a device, and a controller. The device is operative to receive a user input indicating that the device at a user selected position relative to an established fixed reference on the display and capturing a position of the device in order to establish a corresponding reference position. Further, the controller is operative to determine display content on the display based on measured displacement of the device relative to the established reference position.

Another embodiment includes a program storage device readable by a machine, tangibly embodying a (program of instructions executable by the machine to perform a method of providing control of display content on a display with a device. The method performed includes establishing a fixed reference on the display, receiving a user input indicating that the device is at a user selected position corresponding to the fixed reference and capturing a position of the device in order to establish a corresponding reference position, and determining display content on the display based on measured displacement of the pointing device relative to the established reference position.

Other aspects and advantages of the described embodiments will become apparent from the following detailed description, taken in conjunction with the accompanying drawings, illustrating by way of example the principles of the described embodiments.

### BRIEF DESCRIPTION OF THE DRAWINGS

FIG. 1 shows an example of a pointing device controlling position of a cursor on a display,

FIG. 2 shows an example of a pointing device directed to a reference point on a display, and shows angular displacements relative to an established reference position.

FIG. 3 shows an embodiment of a pointing device.

FIG. 4 is a flow chart that includes an example of steps of a method of providing control of display content on a display with a pointing device.

FIG. 5 show an example of a display system that provides control of display content on a display with a pointing device.

FIG. 6 shows an example of a pointing device directed to a reference point on a display, and shows spatial displacement(s) of the pointing device relative to a center-line of an established reference position.

### DETAILED DESCRIPTION

The described embodiments are embodied in providing control of display content of a display with a device. The embodiments utilize measured (or sensed) displacements of the device relative to an established reference position of the device to control the display content (information or data). For an embodiment, the display content includes a cursor, and the measured or sensed displacement of the device controls the position of the cursor on the display. Additionally, spatial displacements of the device can be used to adaptively select a mathematical transformation between the sensed (or measured) displacements and the display content.

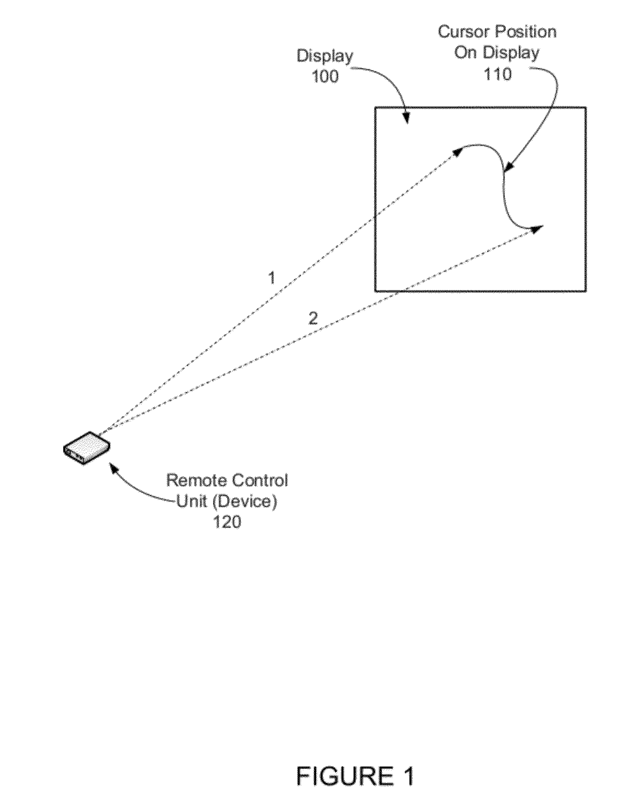

FIG. 1 shows an example of a device 120 (which in some embodiments can be referred to as a pointing device, and in some embodiments can be referred to as a remote control device or unit) controlling position of a cursor 110 on a display 100. A first position of the cursor is directed to a first pointing direction 1 of the device 120 followed by a second position of the cursor as directed by a second pointing direction 2 of the device 120. As previously mentioned, traditional computer input devices do not lend themselves to be used with familiarity or practicality as television remote control input devices, especially to manipulate icons as the means to content navigation. While FIG. 1 shows the device controlling the position of a cursor on the display, it is to be understood that control can be provided for other types of display information other than a cursor. For example, the control can be for menu selection or zoom control of the display information. Additionally, the device itself can be of any form. That is, the device is not to be limited to a remote control unit or a pointing device.

Gesture-based spatial point and select technology is needed, but the current state of the art, affordable technology combination of MEMS gyro and accelerometer only work in relative fashion with respect to three-dimensional motion. This does not allow “scrolling a cursor across the screen” in a computer mouse equivalent drag, pick-up and drag again motion. Center reference is quickly lost and the user has no easy way of controlling the cursor on a television screen in a simple and intuitive manner.

A proposed method of cursor control on a display adopts an absolute spatially referenced pointing technology by the addition of, for example, a magnetometer, to create, for example, a 9 axis AHRS (Attitude Heading Reference System) technology to allow for non-relative cursor reference in such a free-space pointing application with respect to cursor tracking on display screen. This type of absolutely referenced cursor control requires a non-standard interface which does not presently exist. Current devices only track relative movements and also the relative speeds of those movements.

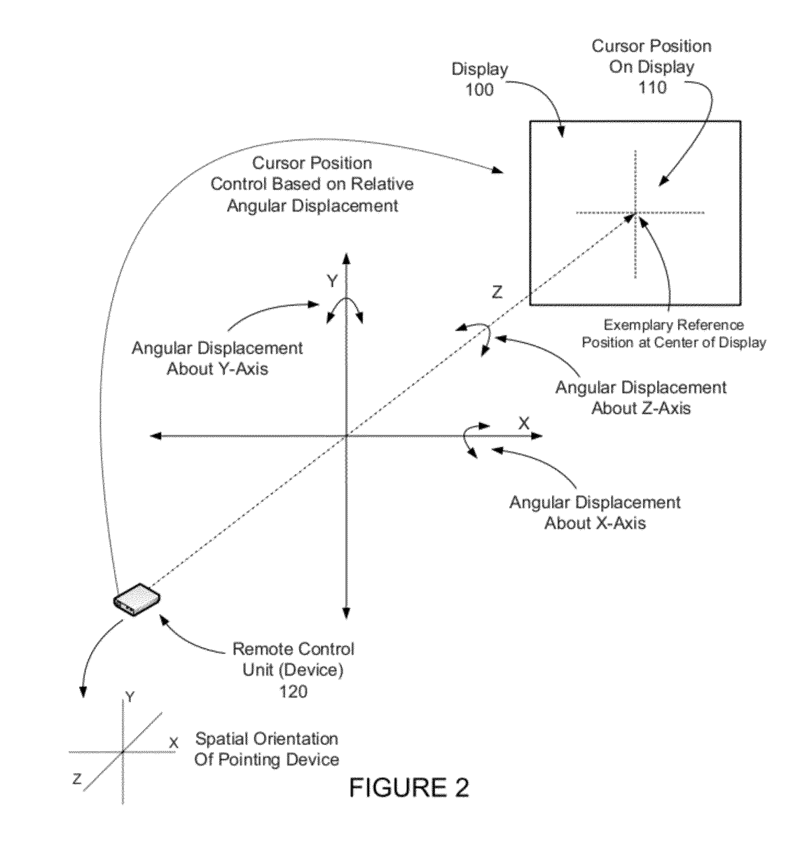

FIG. 2 shows an example of a device 120 directed to a reference point on a display 100, and shows angular displacements relative to an established reference position. That is, the established reference position of the device 120 is determined by a user providing an indication that the device 120 is pointed at a fixed reference in space that corresponds to a cursor position on the display 100. Once the reference position is established, angular displacement (or in other embodiments, spatial displacement) of the device 120 relative to the reference position can be used to control cursor position on the display 100. It is to be understood that the term “pointing” is used loosely. That is, pointing is to be interpreted as setting an orientation (the user holding the pointing device in a fixed position relative to the display) of the pointing device and then the user providing the indication. The orientation of the pointing device at the time of the user provided indication sets or establishes the reference position.

For embodiments, a user indicates a spatial reference position of the device that forms the rotational and/or translational origin of a control frame for any number of interfacing means with a display-based interactive system. The interfacing means may include, but are not limited to, an on-screen cursor, command menus, and gaming scenes.

For embodiments, the reference spatial position of a device is a user-selectable precise starting location of the device in three-dimensional space wherein any movements in the space along any and/or all of X, Y, and Z axes, as well as rotations about these axes, can be tracked and used as control inputs of the display of a display-based user-interactive system.

The reference position can be viewed as a reference point in physical space consisting of a location (such as X, Y, Z) and an orientation (Heading, Pitch and Roll or Quaternion) from a known reference frame (such as North, East, Down). Embodiments include change from the reference position being mapped as a change on the screen (display). For instance, a change in orientation is mapped through scale constants Hscale and Vscale to pointer (for example, a pointing device) movement. This mapping can be performed in the device frame relative to the reference position, or it can be performed in the absolute earth frame.

Described another way, the reference position is an orientation and/or position of the device in an earth reference frame. Measurements of the device in either the device frame or the earth frame provide control of content on the display. Embodiments include the user defining when to link the reference position of the device to a reference position on the display. Earth reference frame control enables the user to experience intuitive motions. For an embodiment, pitching the device up or down in the earth reference frame controls vertical motion while the device reference frame is what is actually measured by the sensors of the device.

The user provided indication can be as simple as the user pressing a button on the device 120 to indicate that the device 120 is directed to the fixed reference on the display 100. Alternatively or additionally, the user provided indication can be determined by sensing motion of the device 120 that indicates action by the user. For example, the user pointing to the center of the display can provide a recognizable natural sequence or series of motions or gestures of the user. That is, users can naturally provide a sequence of motion of the device 120 when attempting to point the device 120 at the display 100. The sequence can be sensed to determine that the user is attempting to point the device 120 at the display 100. Detection of the recognizable sequence of motion can be used to deduce that the user is directing the device 120 to the fixed reference. For example, a gestures motion such as a double tap on the device by ones finger can be detected and used to determine that the user wants to define the current pointing orientation as the new reference position for cursor control.

The fixed reference or fixed references can be established by the display 100 or on the display 100. For example, the center reference can be established by the user pointing the device 120 to the center of the display 100. Alternatively or additionally, a fixed reference can be displayed on the display 100, providing a target for the user to point at, thereby establishing the fixed reference. Additional references can be established by, for example, the edges of the display, or by additional reference points being displayed on the display 100. A plurality of fixed references can be desirable in some situations. References being displayed on the display 100 can be generated by an internal or external controller of the display 100. An example of using multiple references includes the use of a series of motions where the user traces the outside edge of the display to define the orientation and/or location of the controller relative to the display.

For an embodiment, during operation, the user points, for example, a free-space remote control (pointing device or device) at, for example, the center of the screen (display) and then centers the cursor with, for example, a button push, whereupon the cursor position is then tracked from that center reference point in, for example, a scaled absolute coordinate system. Rotations about pitch (angular displacement about the X-axis) and yaw (angular displacement about the ‘Y’-axis) are measured, and then converted into cursor screen position, where, for example, 0.5, 0.5 in Cartesian XY coordinates represents the upper right hand corner of the screen while −0.5, −0.5 represents the lower left hand corner of the screen. In one embodiment, the terms Hpos and Vpos represent X and Y Cartesian coordinates which define the cursor position on the screen. Different scale factors can then be applied or selected by the user to account for the differences in screen size and the distance that the user is positioned from the screen, as well as the responsiveness with which the user desires the cursor to move (sensitivity). A direct one-to-one mapping of movement angle to cursor position on the screen can require the user to sweep far too large a space in order to traverse the length or height of the display and would also make the cursor movement feel far too sluggish. Center in this coordinate system is always set to (0,0). The scaling does not have to only be linear and can be set as non-linear functions as well, which can be used to help to create a superior user control feel and experience.

The orientation or attitude of the controller in the device frame can be defined many ways, such as yaw pitch and roll, quaternions, or direct cosine matrix. In the context described here, the terms orientation and attitude are used interchangeably.

Different users may want a different “feel” for the device. Accordingly, the angles (or in other embodiment, spatial position) defined by the change in attitude (that is, the relative angular displacement) of the device can be adjusted by the Hscale (Horizontal scale) and Vscale (Vertical scale), where the scale of the Hscale sets the physical rotation angles in degrees required to cross the full screen. For example, if Hscale is set to 20, then a relative attitude change of +/−20 degrees in the yaw axis are needed to reach the horizontal edges of the screen. If the scale is set to 10, then only relative attitude change of +/−10 degrees in the yaw axis are needed to reach the horizontal edges of the screen. In one embodiment, the Hpos and Vpos, are calculated by converting the relative attitude change of the device in the device reference frame from the reference attitude. The device reference frame can be defined by the orientation and position of the device. The reference attitude can be defined by the orientation of the device which corresponds to a cursor position on the display.

In another embodiment, the Hpos and Vpos outputs are calculated by converting the relative attitude change of the device in the earth reference frame from the reference attitude. In this embodiment, the user can hold the device in a way that feels natural, or comfortable in his hand, and regardless of the device orientation by the user, the relative attitude change of the device can be translated to cursor position such that hPos represents a yaw rotation in the earth reference frame, vPos represents a pitch rotation in the earth reference frame, regardless of the initial device reference attitude.

In yet another embodiment, the device reference attitude is found by pointing the device with no pitch or roll on it towards the center of the screen. In this embodiment, hPos represents a scaled yaw rotation in both the device and earth reference frame, vPos represents a scaled pitch in both the device and earth reference frame, and roll Angle represents roll around the device axis. In this embodiment, the roll angle is not needed since roll around the device axis does not change where the device is pointed. In the preferred embodiment, the device reference attitude is found by pointing the device at the center of the screen with any device pitch and roll angle. In this embodiment, the hPos can represent a user definable yaw rotation for either the device or earth reference frame and vPos represents a user definable pitch rotation in either the device or earth reference frame. The benefit of this embodiment is that the user can decide if they want the yaw and pitch axis of the device frame or earth frame to result in cursor motion. In other embodiments, the reference attitude can be defined by performing a simple calibration, such as pointing at one or more defined targets on the screen, or tracing the edge of a screen.

In another embodiment, the position outputs hPos and vPos are normalized so that a change of “1.0” covers the whole screen. The benefit of this normalization is to enable hPos and vPos to be easily scaled to any value required by the user's display pointer controls.

For an embodiment, rotation sensors within the pointing device include at least one magnetometer, at least one accelerometer and at least one gyroscope, and it is assumed that the control device is being used in a relatively non-changing magnetic and acceleration reference frame. However, as the orientation and motion sensors improve, or their fusion gets better, even this assumption no longer has to hold true. Although the user may use the push button to center the cursor on the screen, a user gesture (such as a unique wiggle, or shake) can also signal screen center even without a button push. Embodiment can include an adaptive, self-learning algorithm that can learn a user's unique movements when the remote control (pointing device) is aimed at the screen's center as well.

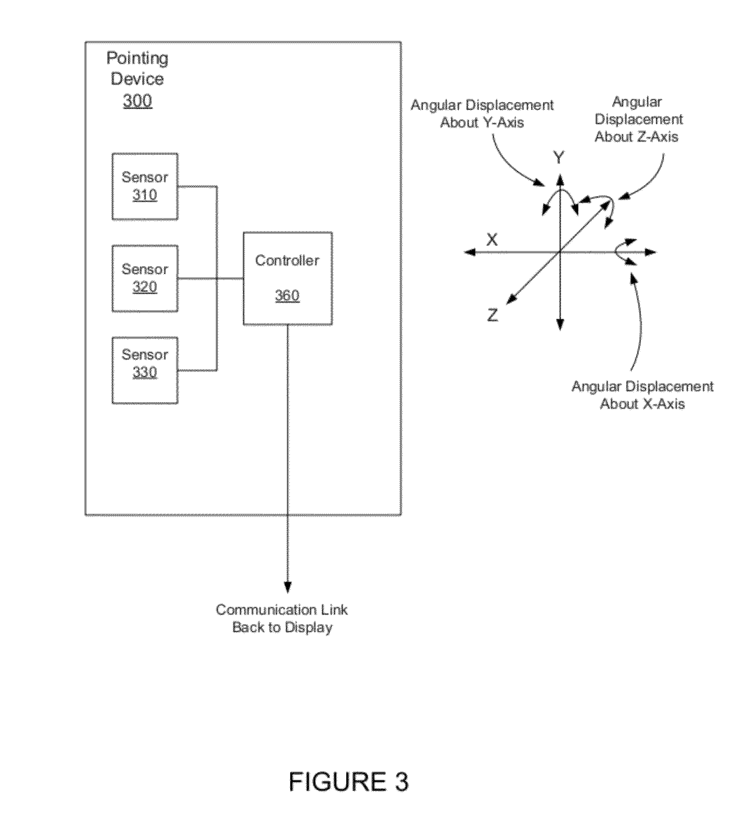

FIG. 3 shows an embodiment of a pointing device 300. The pointing device 300 includes sensors 310, 320, 330 for sensing relative angular (or spatial) displacement of the pointing device. The sensors can include a magnetometer, an accelerometer and/or a gyroscope. As described, the sensors 310, 320, 330 sensed relative angular rotation of the pointing device. For an embodiment, the sensors 310, 320, 330 provide a 9 axis AHRS (Attitude Heading Reference System) that allow for non-relative cursor reference in a free-space pointing application with respect to cursor tracking on a display screen.

The device 300 can include a controller 360 for general management of the sensors 310, 320, 330, or additionally, some processing of the sensed signals of the sensors 310, 320, 330. The controller can be coupled to another controller or the display through some sort of communications link that can be wired or wireless.

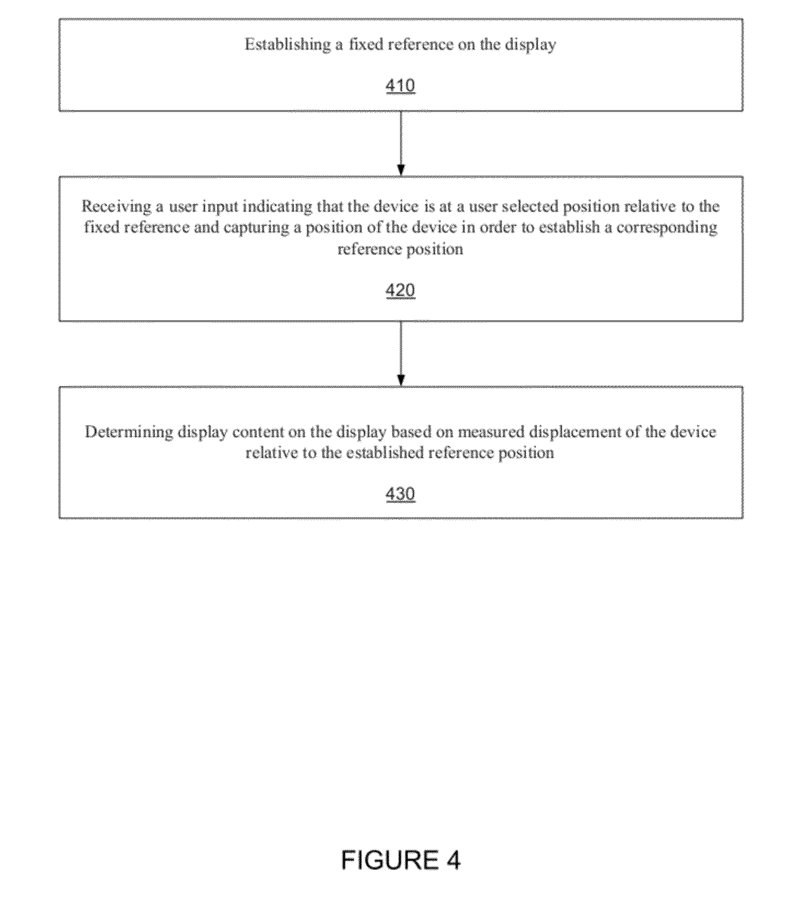

FIG. 4 is a flow chart that includes an example of steps of a method of providing control of display content on a display with a device. A first step 410 includes establishing a fixed reference on the display. A second step 420 includes receiving a user input indicating that the device is at a user selected position corresponding can include relative to) to the fixed reference and capturing (capturing can include storing the reference position for future reference) a position of the device in order to establish a corresponding reference position. A third step 430 includes determining display content (for an embodiment, the display content includes a position of a cursor) on the display based on measured displacement of the device relative to the established reference position.

For an embodiment, capturing (the capturing can be simultaneous or near-simultaneous for the described embodiments) the position of the device in order to establish the corresponding reference position includes capturing an angular orientation of the device in order to establish the corresponding reference position. For another embodiment, capturing the position of the device in order to establish the corresponding reference position includes capturing a spatial position of the device in order to establish the corresponding reference position. For another embodiment, capturing the position of the device in order to establish the corresponding reference position includes capturing an angular orientation and a spatial position of the device in order to establish the corresponding reference position.

Various valuable implementations can be realized by capturing both angular orientation and spatial position. For example, angular displacements can be used for controlling one type of content (information or data) displayed on the display, and the spatial displacements can be used for controlling a different type of content (information or data) being displayed. For example, angular displacement could be used for controlling a position of a cursor, whereas the spatial displacement is used for controlling a zoom feature of the display. The number of possibilities are really unlimited, but are based on the use of angular displacement for one type of display control and spatial displacements for another type of control. Another possible control includes menu selections of menus being displayed on the display. In summary, an embodiment includes a first type of display content being controlled based on measured angular displacement of the device relative to the established reference positions, and a second type of display content being controlled based on measured spatial displacement of the device relative to the established reference position.

For an embodiment, the fixed reference is proximate to a center of the display. An embodiment includes the fixed reference being generated and displayed on the display.

For an embodiment, the user input is received by the user pressing a button on the pointing device. An embodiment includes the user input includes identification of a user gesture. For an embodiment, the identification of the user gesture includes identifying a predetermined sequence of motions. For a more specific embodiment, the predetermined sequence of motions includes a natural sequence of motions of the user when the user is performing a particular action. A gesture motion, such as a tap, or double tap with a finger could be used to indicate when the user wants to reset the reference alignment (that is, establish a new reference position). The benefit of using the gesture is that it eliminates the need to use a button on the remote (pointing device).

Embodiments further include adaptively selecting the mathematical transformation based upon a user selection. For an embodiment the mathematical transformation is adaptively selected based upon an application of the pointing device by the user. For an embodiment, the mathematical transformation is a linear transformation. For another embodiment, the mathematical transformation is a non-linear transformation. For another embodiment, the mathematical transformation is a scaled transformation. For another embodiment, the mathematical transformation is an un-scaled transformation. The processing of the mathematical transformation can occur within the pointing device, within the display, or outside of the pointing device and the display.

An embodiment includes adaptively selecting a sensitivity of the mathematical transformation based at least in part on a rate of change of the cursor position on the display. More specifically, an embodiment includes selecting the sensitivity to be lower when the cursor is at rest than when the cursor is in motion. This approach allows maintenance of absolute accuracy of orientation while eliminating unwanted effects from sensor noise by defining the sensitivity such that below a predefined threshold, displacement results in no cursor motion. Above the limit, the cursor motion starts and maintains the cursor position relative to the reference alignment orientation.

An embodiment includes measuring spatial displacement of the device relative to a reference spatial position of the device, wherein the reference spatial position is acquired when the user input is received. Various methods can be used for sensing the spatial location, or spatial displacement of the device. For an embodiment, the reference spatial position of the device is defined by the user tracing the edges of the display, as if using a laser pointer, while keeping the device at a constant location. The spatial position can be determined, for example, by beacons that transmit audio signals being distributed around a location in which the device is being utilized. The device can estimate its location by triangulating audio signals received from each of the beacons. Based on an estimated transmission time of each of the received audio signals and based on knowledge of locations of each the beacons, the location of the device can be estimated. Other methods of identifying the relative location of the device can alternatively be used. Other technologies for position sensing include, for example, ultra wide band technologies, and camera based technologies.

For an embodiment the position of the cursor on the display is determined based on a mathematical transformation of the measured angular displacement or spatial displacement of the device relative to the established reference position (as described), and further including selecting the mathematical transformation based at least in part on the measured spatial displacement of the pointing device.

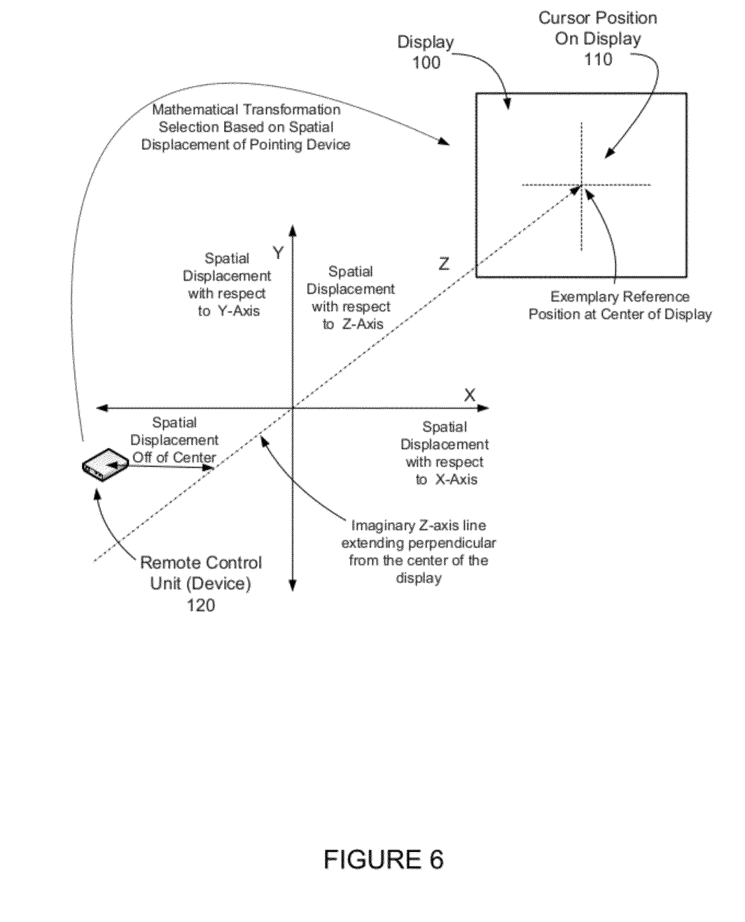

An embodiment includes monitoring a distance the device is spatially oriented off-center (can be referred to as “off-axis” from the fixed reference of the display. The term “spatially oriented off-center from the fixed reference of the display” shall be shown in FIG. 6 and described in the associated description of FIG. 6. Basically, spatially off-center (off-axis) distances convey that the device (or the user operating the device) has wandered to a side (vertical or horizontal) of the display, and are viewing the display at an angle. The angle can be determined by the distance the pointing device is from the display, and the distance the device is off-center (off-axis) from a perpendicular line from the center of the display. For an embodiment, if the distance (from off-center) is greater than a threshold then the mathematical transformation is selected to be non-linear, and if the distance is less than the threshold, then the mathematical transformation is selected to be linear.

Various methods and configuration can be used for measuring the displacement of the device, and various configurations of sensors can be utilized. For an embodiment, angular displacement is measured by at least one inertial angular rotation sensor. For another embodiment, the angular displacement is measured by a combination of at least two linear inertial sensors configured to measure rotational displacement about an axis of rotation. For another embodiment, the angular displacement is measured by at least one magnetic sensor configured to measure rotation. For another embodiment, the angular displacement is measured by at least one inertial angular rotation sensor, and at least one magnetic sensor configured to measure rotation. For another embodiment, the angular displacement is measured by a combination of at least two linear inertial sensors configured to measure rotational displacement about an axis of rotation, at least one magnetic sensor configured to measure rotation. For another embodiment, the angular displacement is measured by at least one inertial angular rotation sensor, and at least one magnetic sensor configured to measure rotation, and a combination of at least two linear inertial sensors configured to measure rotational displacement about an axis of rotation.

For another embodiment, the angular displacement is measured by at least one inertial angular rotation sensor, at least one magnetic sensor configured to measure rotation and at least one linear inertial sensor configured to measure rotation.

For another embodiment, the angular displacement is measured by a combination of at least two linear inertial sensors configured to measure rotational displacement about an axis of rotation, at least one magnetic sensor configured to measure rotation about and at least one linear inertial sensor configured to measure rotation about a gravitational reference field.

For another embodiment, the angular displacement is measured by at least two inertial angular rotation sensors, three magnetic sensors configured to measure rotation about a magnetic reference field and three linear inertial sensors configured to measure rotation about a gravitational reference field.

For another embodiment, the angular displacement is measured by three inertial angular rotation sensors, three magnetic sensors configured to measure rotation about a magnetic reference field and three linear inertial sensors configured to measure rotation about a gravitational reference field.

For another embodiment, the angular displacement is measured by a combination of at least four linear inertial sensors configured to measure rotational displacement about two axes of rotation, at least one magnetic sensor configured to measure rotation about a magnetic reference field and at least one linear inertial sensor configured to measure rotation about a gravitational reference field.

For another embodiment, the angular displacement is measured by a combination of at least six linear inertial sensors configured to measure rotational displacement about three axes of rotation, three magnetic sensors configured to measure rotation about a magnetic reference field and three linear inertial sensors configured to measure rotation about a gravitational reference field.

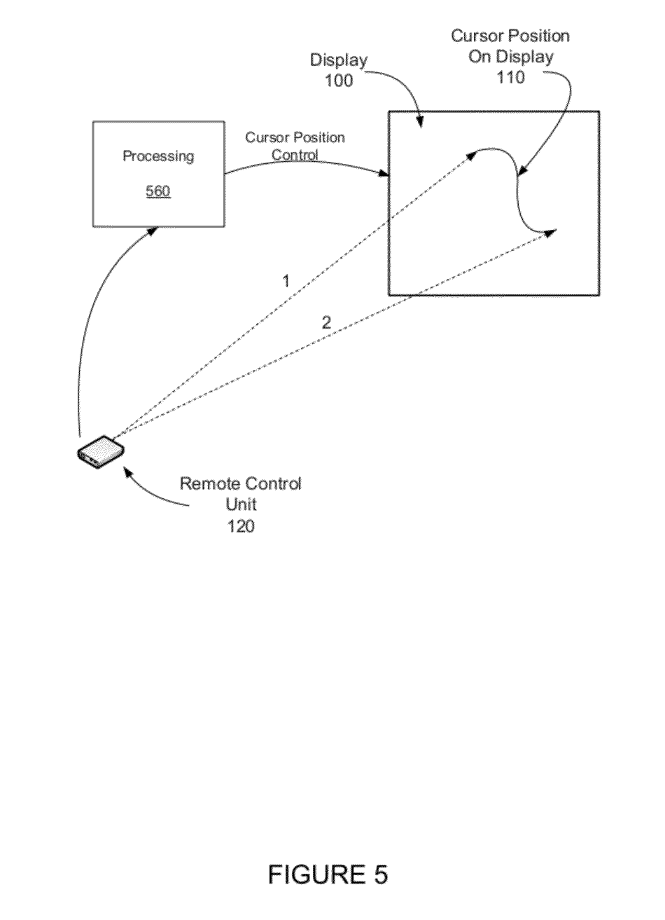

FIG. 5 show an example of a display system that provides control of a cursor on a display with a device. The fundamental concept to be conveyed is that while the angular displacement (or spatial displacement) measurements occur within the device (remote control unit) 120 and the cursor being controlled is on the display 110, the processing of the sensed signals of the sensors can occur anywhere. As shown, a processing unit 560 provides the processing to control the position of the cursor on the display 100. All or any subset of the total processing can occur within the device 120, the display 110 or within an external processing unit 560. That is, the controller can include sub-controllers located within the display 100 or the device 120, or be at least partially located separate from the display 100 and the device 120.

FIG. 6 shows an example of a device 120 directed to a reference point on a display 100, and shows spatial displacement(s) of the device 120 relative to a center-line of an established reference position. For an embodiment, the center-line is an approximately perpendicular line that extends from the center of the display 110. When the user provides a user input indicating that the device is pointed at, for example, the fixed reference, a reference spatial position of the device can be determined. The relative spatial position of the device can then be monitored to aid in the selection of the mathematical transformation.

An embodiment includes monitoring a distance the device is from the display, and adaptively selecting a scaling factor of the mathematical transformation based on the distance. If, for example, the relative spatial position changes along the Z-axis, the scaling factor of the mathematical transformation can be increased or decreased. That is, for example, if the spatial position of the device changes so that the device 120 is closer to the display 110, the scaling factor can be increased. Or, for example, if the spatial position of the device changes so that the device 120 is farther from the display 110, the scaling factor can be decreased.

An embodiment includes monitoring a distance the device 120 is spatially oriented off-center (off-axis) from the fixed reference of the display 100. As previously mentioned, a center-line can be envisioned that extends perpendicularly from the center of the display 100. As the device 120 spatially moves along either the Y-axis or the X-axis, the mathematical transformation can include a selection of non-linear scaling. For an embodiment, if the distance (from the center-line) is greater than a threshold then the mathematical transformation is selected to be non-linear, and if the distance is less than the threshold, then the mathematical transformation is selected to be linear. The adaptive scaling based on measurement of off-axis of the device, and based on the distance the device is from the display, can be useful in controlling display content, for example, in a first person shooter game. The adaptive features ensures the orientation defined by the device correctly maps to shooting targets in the display content on the display.

It is to be understood that the methods of the described embodiments can be executable by a software program that causes a device to perform the appropriate steps of the methods. For example, a downloadable program can include executable steps that cause a device to perform the steps of the described embodiments. That is, the device can be a program storage device readable by a machine, tangibly embodying a program of instructions executable by the machine to perform a method of providing control of a cursor on a display with a device. The device can be, for example, a smart phone that includes hardware (and/or software) to perform the following steps when executed: establishing a fixed reference on the display, receive a user input indicating that the device is at a user selected position corresponding to the fixed reference and capture a position of the device in order to establish a corresponding reference position, and determine a display content on the display based on measured displacement of the pointing device relative to the established reference position.

Although specific embodiments have been described and illustrated, the described embodiments are not to be limited to the specific forms or arrangements of parts so described and illustrated. The embodiments are limited only by the appended claims.

What is claimed:

1. A method of providing control of display content on a display with a device, comprising:
establishing a fixed reference on the display;
receiving a user input indicating that the device is at a user selected position corresponding to the fixed reference and capturing a position of the device in order to establish a corresponding reference position;
determining display content on the display based on measured displacement of the device relative to the established reference position.

2. The method of claim 1, wherein the display content comprises a position of a cursor on the display.

3. The method of claim 1, wherein capturing the position of the device in order to establish the corresponding reference position comprises capturing an angular orientation of the device in order to establish the corresponding reference position.

4. The method of claim 1, wherein capturing the position of the device in order to establish the corresponding reference position comprises capturing a spatial position of the device in order to establish the corresponding reference position.

5. The method of claim 1, wherein capturing the position of the device in order to establish the corresponding reference position comprises capturing an angular orientation and a spatial position of the device in order to establish the corresponding reference position.

6. The method of claim 5, further comprising controlling a first type of display content based on measured angular displacement of the device relative to the established reference positions, and controlling a second type of display content based on measured spatial displacement of the device relative to the established reference position.

7. The method of claim 1, wherein the fixed reference is proximate to a center of the display.

8. The method of claim 1, wherein the fixed reference is generated and displayed on the display.

9. The method of claim 1, wherein the user input is received by the user pressing a button on the pointing device.

10. The method of claim 1, wherein the user input comprises identification of a user gesture, wherein the user gesture comprises identifying a predetermined sequence of motions.

11. The method of claim 10, wherein the predetermined sequence of motions comprise natural sequence of motions of the user when the user is performing a particular action.

12. The method of claim 3, wherein the angular displacement is measured about at least one of an axis of yaw or an axis of pitch.

13. The method of claim 12, wherein the angular displacement measurements are independent of a roll angle of the device.

14. The method of claim 2, wherein the position of the cursor on the display is determined based on a mathematical transformation of the measured displacement of the device relative to the established reference position.

15. The method of claim 14, further comprising adaptively selecting the mathematical transformation based upon a user selection.

16. The method of claim 14, further comprising adaptively selecting the mathematical transformation based upon an application of the device by the user.

17. The method of claim 14, wherein the mathematical transformation comprises scaling, wherein the scaling includes a scaling factor that is selectable by the user to account for the differences in display size and a distance that the user is positioned from the display.

18. The method of claim 14, wherein the mathematical transformation comprises scaling, wherein the scaling includes a scaling factor that is selectable by the user to allow the user to select a responsiveness of the cursor.

19. The method of claim 14, further comprising adaptively selecting a sensitivity of the mathematical transformation based at least in part on a rate of change of the cursor position on the display.

20. The method of claim 19, wherein the sensitivity is lower when the cursor is at rest than when the cursor is in motion.

21. The method of claim 1, further comprising measuring spatial displacement of the device relative to a reference spatial position of the device, wherein the reference spatial position is acquired when the user input is received.

22. The method of claim 21, wherein the display content on the display is determined based on a mathematical transformation of the measured displacement of the device relative to the established reference position, and further comprising selecting the mathematical transformation based at least in part on the measured spatial displacement.

23. The method of claim 22, further comprising monitoring a distance the device is from the display, and adaptively selecting a scaling factor of the mathematical transformation based on the distance.

24. The method of claim 22, further comprising monitoring a distance the device is spatially oriented off-axis from the fixed reference of the display.

25. The method of claim 24, wherein if the distance is greater than a threshold then selecting the mathematical transformation to be non-linear, and if the distance is less than the threshold, then selecting the mathematical transformation to be linear.

26. The method of claim 1, wherein the display content comprises a cursor, and a cursor position on the display spans from a first edge of the display to a second edge of the display.

27. The method of claim 3, wherein the angular displacement is measured by at least one inertial angular rotation sensor.

28. The method of claim 3, wherein the angular displacement is measured by a combination of at least two linear inertial sensors configured to measure rotational displacement about an axis of rotation.

29. The method of claim 3, wherein the angular displacement is measured by at least one magnetic sensor configured to measure rotation about a magnetic reference field.

30. The method of claim 3, wherein the angular displacement is measured by at least one inertial angular rotation sensor, and at least one magnetic sensor configured to measure rotation about a magnetic reference field.

31. The method of claim 3, wherein the angular displacement is measured by a combination of at least two linear inertial sensors configured to measure rotational displacement about an axis of rotation, at least one magnetic sensor configured to measure rotation about a magnetic reference field.

32. The method of claim 3, wherein the angular displacement is measured by at least one inertial angular rotation sensor, and at least one magnetic sensor configured to measure rotation about a magnetic reference field, and a combination of at least two linear inertial sensors configured to measure rotational displacement about an axis of rotation.

33. A device, comprising:
means for receiving a user input indicating that the device is at a user selected position relative to an established fixed reference on a display;
means for receiving the user input and capturing a position of the device in order to establish a corresponding reference position, wherein
display content on the display is determined based on measured displacement of the device relative to the established reference position.

34. The device of claim 33, wherein the display content comprises a cursor, and further comprising means for determining a cursor position on the display based on measured displacement of the device relative to the established reference position.

35. The device of claim 34, the means for receiving the user input and capturing the position of the device in order to establish the corresponding reference position comprises capturing an angular orientation of the device in order to establish a corresponding reference position, and wherein the angular displacement is measured by at least one inertial angular rotation sensor, and at least one magnetic sensor configured to measure rotation about a magnetic reference field, and a combination of at least two linear inertial sensors configured to measure rotational displacement about an axis of rotation.

36. A display system, comprising:
a display;
a device;
the device operative to receive a user input indicating that the device at a user selected position relative to an established fixed reference on the display and capturing a position of the device in order to establish a corresponding reference position;
a controller operative to determine a display content on the display based on measured displacement of the device relative to the established reference position.

37. A program storage device readable by a machine, tangibly embodying a program of instructions executable by the machine to perform a method of providing control of a cursor on a display with a device, comprising:
establishing a fixed reference on the display;
receiving a user input indicating that the device is at a user selected position corresponding to the fixed reference and capturing a position of the device in order to establish a corresponding reference position;
determining a display content on the display based on measured displacement of the pointing device relative to the established reference position.
